(19) United States
(12) Patent Application Publication
(10) Pub. No.: US 2025/0106128 A1
(43) Pub. Date: Mar. 27, 2025

(54) ENHANCED TELEMETRY FOR NETWORK-BASED COMMUNICATIONS

(71) Applicant: Microsoft Technology Licensing, LLC, Redmond, WA (US)

(72) Inventors: Pritesh Rajesh KANANI, Bellevue, WA (US); Mantian Helen Lin, Seattle, WA (US); Siunie Aquawati Sutjahjo, Redmond, WA (US); Wei Zhong, Redmond, WA (US)

(21) Appl. No.: 18/371,836

(22) Filed: Sep. 22, 2023

(51) Int. Cl. H04L 43/045; G06T 17/00

(52) U.S. Cl. CPC H04L 43/045; G06T 17/00

(57) ABSTRACT

Disclosed in some examples are methods, systems, and machine-readable mediums that that utilize targeted telemetry in a highly complex UI such as a 3D UI using dynamic object references, subscription-based retrieval, and hierarchical object model to provide advanced telemetry streams. These streams may be used in accurately diagnosing issues in real-time for highly complex UI environments, such as 3D communication systems. While a 3DCS is used herein as an example of an environment to which the present disclosure is applicable, one of ordinary skill in the art with the benefit of the present disclosure will appreciate that the techniques described here may be applied to other highly complex and dynamic environments as well.

### TECHNICAL FIELD

Embodiments pertain to telemetry of complex communication sessions. Some embodiments relate to enhanced real-time element telemetry in a three-dimensional communication session.

### BACKGROUND

Programming issues, also known as bugs, are defects in software that cause unintended program operation. Programming issues (hereinafter “issues”) are a common concern for software developers, and a common annoyance for software users. Issues include for example, malfunctions, crashes, inoperable features, poor performance, unhandled error conditions, and other unexpected or undesired program behavior. Issues may be caused by the program itself, or by a piece of software or hardware used by the program, such as an operating system, processor, memory, network connection, remote service, database, peer user's software, peer user's device, third party library, etc. In addition, issues may be caused by poor configuration, not enough processing hardware, network issues, and the like.

Users often submit reports describing these issues. For example, in a video conference application, users may report that “I cannot join a meeting”, “I tried to call this person, but the call failed”, or “I can't see this person's video or screen share.” Reports such as these may be submitted with log files, telemetry data, crash dumps, and other types of diagnostic data. This diagnostic data is useful in after-the-fact investigations and remediation activity but is difficult to analyze in real-time to fix the issue. Additionally, as the complexity of modern communication systems grows, so does the complexity of such diagnostic data.

In addition to after-the-fact logging, communication systems often provide what is called telemetry data, which is diagnostic data collected about elements in the communication that may be streamed to one or more users such as administrators to assist in diagnosing and fixing issues in real-time. Telemetry data may be data collected about a communication session that tracks data about the communication session. Examples include jitter, packet loss, audio quality, and the like.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a three-dimensional communication session (3DCS) according to some examples of the present disclosure.

FIG. 2 illustrates a communications system according to some examples of the present disclosure.

FIG. 3 illustrates a block diagram of a telemetry component according to some examples of the present disclosure.

FIG. 4 illustrates a flowchart of a method of providing telemetry data according to some examples of the present disclosure.

FIG. 5 is a block diagram illustrating an example of a machine upon which one or more embodiments may be implemented.

### DETAILED DESCRIPTION

Three-dimensional (3D) environments may present content, such as user videos or avatars in a 3D environment where they may interact with one another in a computer-generated world. The world may be modeled after items or places in the real world or may be created by an artist or designer. Communication sessions utilizing the 3D user interface environment (hereinafter 3DCS) may provider richer interactions between users and foster an improved sense of togetherness over traditional communication sessions that feature 2D user interfaces. 3DCS may include virtual meeting rooms where remote users are placed as avatars in a virtual meeting room. Other 3DCS may include virtual events such as conferences and trade shows where participants may virtually walk around a virtual conference hall to view exhibits.

Such 3DCs may feature thousands of dynamic elements, from textures, avatars, meshes, vertexes, points, videos, content, and the like. These dynamic elements are created and destroyed as the 3D elements are introduced into, and removed from, the 3D environment. For example, a user may hang up the communication session on their end and thus be removed from the communication session. In other examples, various 3D objects may enter and leave the 3D environment. Each time the 3D object enters and leaves, a data structure describing the object may be created and/or destroyed.

In 3DCS environments the telemetry data may include data about 3D elements. In such an environment, the system may track and monitor various parameters for each object. The telemetry data allows for accurate and sophisticated diagnosis of issues in the 3D communication session. Despite this, the sheer volume of objects and the volume of possible parameters and data collected about the 3D environment is enormous and thus presents technical problems in accurately filtering the large amount of generated telemetry data in a reasonable amount of time to find a root cause of a potential problem. Diagnosing an issue live in a communication session with a 3D environment may require sifting through millions of potential data points.

Disclosed in some examples are methods, systems, and machine-readable mediums that that utilize targeted telemetry in a highly complex UI such as a 3D UI using dynamic object references, subscription-based retrieval, and hierarchical object model to provide advanced telemetry streams. These streams may be used in accurately diagnosing issues in real-time for highly complex UI environments, such as 3D communication systems. While a 3DCS is used herein as an example of an environment to which the present disclosure is applicable, one of ordinary skill in the art with the benefit of the present disclosure will appreciate that the techniques described here may be applied to other highly complex and dynamic environments as well.

In some examples, the system may build a hierarchical object model based upon the 3D UI. The object model comprises both objects that represent elements of the three dimensional environment and links between those objects that represents a relationship between the objects. Example relationships may include parent-child relationships, category relationships, and the like. For example, a video screen within the environment may be a canvas, with an associated texture, and content on the canvas and texture. The object model may model this as a canvas object, a texture object, and a content object—with relationships between them.

The hierarchical object model may be created as part of creating the complex UI. For example, as the system builds the 3D environment, memory may be allocated for the object, a data structure of the object may be populated with data about the object, and the data structure may be inserted into the object model at a point representative of a relationship of the object to other objects (e.g., as a child object of a parent). Telemetry data, as it is generated, may then be associated with the object it corresponds to. For example, jitter buffer depth data may be associated with the jitter buffer of an object of a particular participant. For example, the telemetry data may be a JavaScript Notation (JSON) stream and the telemetry data may specify an object identifier of the object it relates to. In other examples, rather than being built as part of creating the complex UI, the hierarchical object model may be built by the telemetry system for the purposes of filtering the telemetry data and may be created based upon log files including the telemetry data.

As noted, each object in the model may be associated with telemetry data. For example, certain data already collected may be associated with a particular object. In other examples, each object may have an object type that may specify telemetry data that may be collected about the object, but which is not already being collected. Administrators or other users may then subscribe to telemetry data using the hierarchical object model. Once a user subscribes to the telemetry data associated with an object, the telemetry data is transmitted to the user, if already collected. If the telemetry data is not collected already, the data may be collected (e.g., the telemetry tracking for that data may be turned on) and then streamed to the user. In some examples, the telemetry is collected and transmitted by a client application in the communication session. In examples in which telemetry data is only collected and streamed when the data is of interest to users, the system may reduce the amount of data collected and transmitted. This may reduce processing power needed for this data, reduce latency, and reduce network impacts of this data.

As noted, users may directly subscribe to receive specific telemetry data from specific objects, or may utilize one or more queries to subscribe to receive telemetry data. Once subscribed, telemetry data matching the query may be streamed, as it is collected, to one or more users. This enables users to view and diagnose a particular UI environment in real-time.

Queries may be used to specify which objects and which telemetry data for each object to transmit to the user. For example, while a subscription may directly specify one or more objects and telemetry data for that object to stream, in other examples a query may dynamically specify one or more objects. For example, queries may be used to match object properties such as a class or type of object (e.g., a mesh element), one or more objects with a specified relationship to one or more other objects (e.g., a distance between objects in the UI, a visibility of objects in the UI from a particular user's perspective, parent objects, child objects, or the like), one or more telemetry properties of objects (e.g., the query may request all objects with a jitter that meets a threshold), and the like. The query may be in the form of one or more conditional statements and telemetry data matching the subscription query is then streamed to a particular user or location for storage or review.

Subscriptions may be setup using a UI provided by the system that may present the object model. Users may individually select each object or class of objects that they are interested in receiving telemetry data for. In other examples, the system may present one or more simplifications to the object hierarchy model. For example, the full model may have thousands of objects and even more relationships between objects. In some examples, the system may filter the object hierarchy model to include a list of users, virtual objects, and other objects. The filtering may be done using one or more rules that may aggregate multiple objects or object types into one or more single object or object type representations, hide certain objects or object types, and highlight certain objects or object types that may be typically less interesting for users. This simplified UI may be presented to users for selecting one or more objects or object types to subscribe to telemetry from those selected objects or object types. In other examples, a user may be provided with a view of the 3D environment and may graphically select one or more objects. In some examples, this view may be from the perspective of a selected user. Responsive to this selection, a list of telemetry data that may be subscribed to may be displayed. The user may then select one or more of the telemetry data and then begin to receive that data as a subscription. Thus, an administrator may obtain a view of what a participant sees and may select one or more objects in the UI to subscribe to debug a particular user's view.

As can be appreciated, subscriptions may be modified or canceled to remove telemetry data or cancel all telemetry data. In addition, as telemetry data may arrive from one or more client devices of participants, the telemetry data may arrive out-of-order. To preserve a sequential ordering, the telemetry data may have timestamps. The system may include one or more buffers and telemetry data that arrives may be rearranged within the buffer so as to present a sequential ordering. Additionally, as the 3D environment is dynamically changing, objects may be created and destroyed such that the object model responds to changes in the 3D environment. Each object may have an object identifier that uniquely identifies an object in the 3D environment. Because objects are stored as data structures, providing globally unique identifiers for all objects within the entirety of the 3D communication session environment may require the use of large amounts of memory to hold the possibly large identifiers. To reduce the size of these identifiers, and thus, to reduce the amount of memory that the object map uses, identifier numbers may be re-used. To correlate telemetry from two different objects with a same identifier, the telemetry timestamps may be used. For example, at a first time range, a first object identifier may be assigned to a first object and at a second time range, the first object identifier may be assigned to a second object. Telemetry arriving within the first time range with the first object identifier may be associated with the first object and sent to users subscribing to receive telemetry from the first object. Telemetry arriving within the second time range with the first object identifier may be associated with the second object.

The disclosed techniques thus solve the technical problem of automatically filtering data from massive amounts of diagnostic data in real-time using the technical solution of hierarchically organizing said data and applying one or more queries to said hierarchical organization of the data. The present disclosure thus provides a technological solution to a technological problem specific to computer-based communications sessions. The present disclosure also improves the functionality of the computing devices by improving the ability of the devices to detect errors in data in real-time by providing granular, nuanced, and useful classifications of telemetry data.

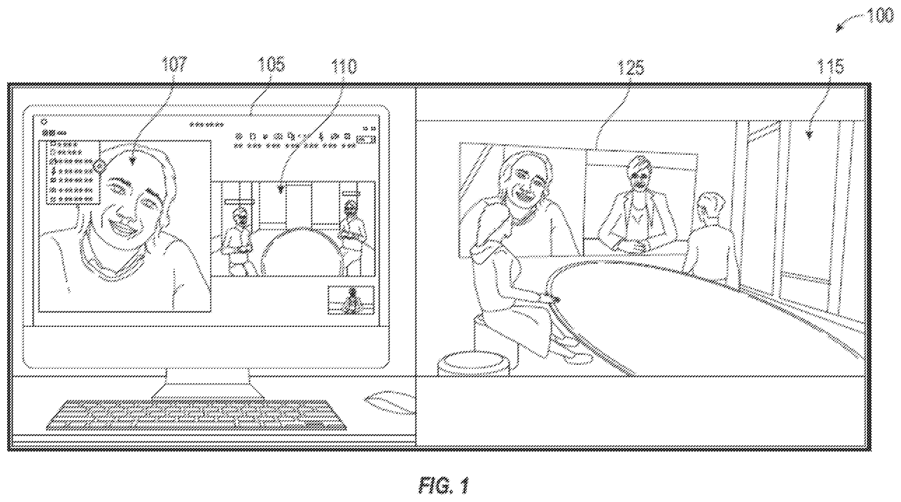

FIG. 1 illustrates a 3DCS 100 according to some examples of the present disclosure. One view 105 of the GUI includes a participant image 107 and a 3D view of a conference room 110 with avatars representing other participants. For some remote users, they may utilize avatars that are part of a virtual conference room 115. Virtual conference room 115 may have a number of virtual objects, such as floors, tables, chairs, walls, screens, such as screen 125. The avatars may represent users that are part of a virtual reality environment and may represent real users. The avatars may utilize motion tracking to move as the real users move. In some examples, remote users not participating in the virtual reality environment may have their camera stream projected onto a screen 125. The 3DCS 100 may have an object model with numerous objects. For example, each avatar may be a child object of the user that it represents and may have various grandchild objects specifying the appearance of the object.

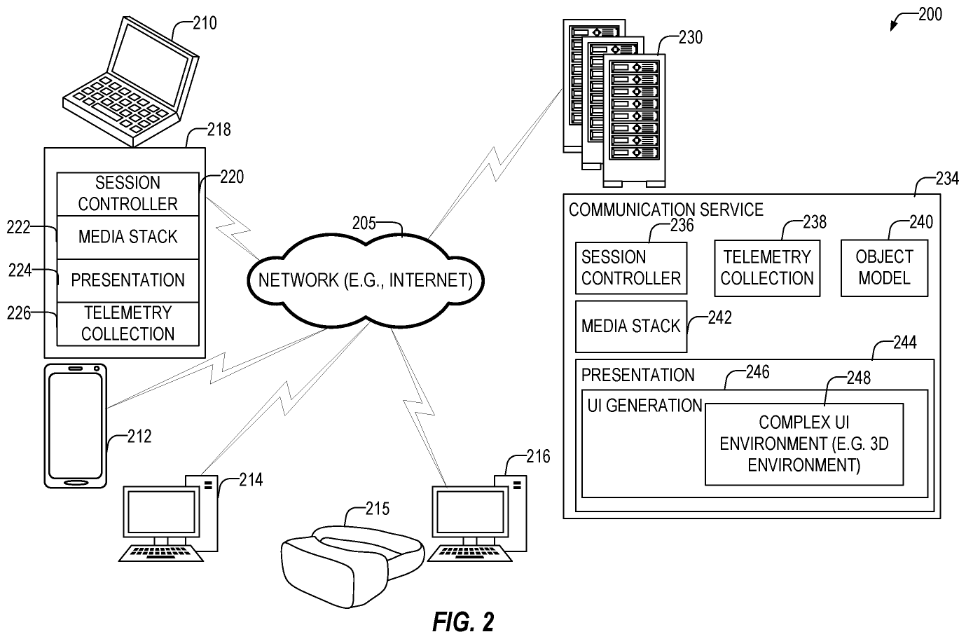

FIG. 2 illustrates a communications system 200 according to some examples of the present disclosure. User computing devices 210, 212, 214, and 216 may connect over network 205 to a communication server 230 of a communication service 234 to participate in one or more communication sessions. The user computing devices 210, 212, 214, and 216 may include a variety of devices, such as personal computers, desktops, workstations, tablets, smartphones, and the like. In some examples, the user computing devices may utilize one or more peripherals to interface with the communication session, such as virtual reality goggles 215, shown connected to the user computing device 216.

One or more communication servers 230 execute a communication service 234. Communication service 234 utilizes hardware of the one or more communication servers 230 to provide communication sessions by which users utilizing communication applications, such as client communication application 218 may communicate with each other in a communication session by exchanging audio, video, and other communications data. In some examples, the communication session may be a 3DCS with 3D elements. The user computing devices 210, 212, 214, and 216 may access the communication service through one or more client communication applications, such as client communication application 218. The client communication application 218 may be a dedicated application or may be a browser-based application served from the communication service 234.

The communication service 234 may include a session controller 236 which may, in conjunction with session controller 220 of client applications, such as client communication application 218, handle signaling flows to setup, tear down, and modify the communication sessions. Media stack component 242 of the communication service 234 may, along with the media stack 222 of the client application, such as client communication application 218, may implement protocols (e.g., Real-Time Transport Protocol RTP) and functionality for sharing media in the communication session. Media sent by the media stack of the communication applications participating in the communication sessions such as media stack 222 may be processed by media stack component 242 of the communication service 234. Media shared may include audio, video, content, data, and the like. In addition, media shared by user computing devices may include, for 3DCS, user positioning data or the like such that the user may navigate through the 3D environment.

Presentation component 244 may utilize media delivered through the media stack component 242 to mix media and create a session presentation. For example, by creating one or more GUI descriptors that describe a GUI that is then delivered to the client applications, which are then utilized by the presentation component of the client application, such as presentation component 224 of the client communication application 218. GUI descriptors include data describing a UI, including media, its placement within a UI, and the like. Example UI descriptors include Hypertext Markup Language (HTML) pages, Cascading Style Sheets (CSS), scripting code such as JavaScript, Java code, data files, and the like. UI descriptors may also include media. Presentation component 244 may include UI generation component 246 which may create one or more complex UI environments 248 such as a 3D environment or 3DCS environments such as shown in FIG. 1.

Telemetry collection component 238 communicates with telemetry collection components of communication applications, such as telemetry collection component 226 of client communication application 218 to subscribe to and collect telemetry about one or more communication sessions. Telemetry collection component 238 may utilize object model 240, which may be created by telemetry collection component 238 or the UI generation component 246. The object model 240 may represent the communication session and in particular the complex UI environment 248.

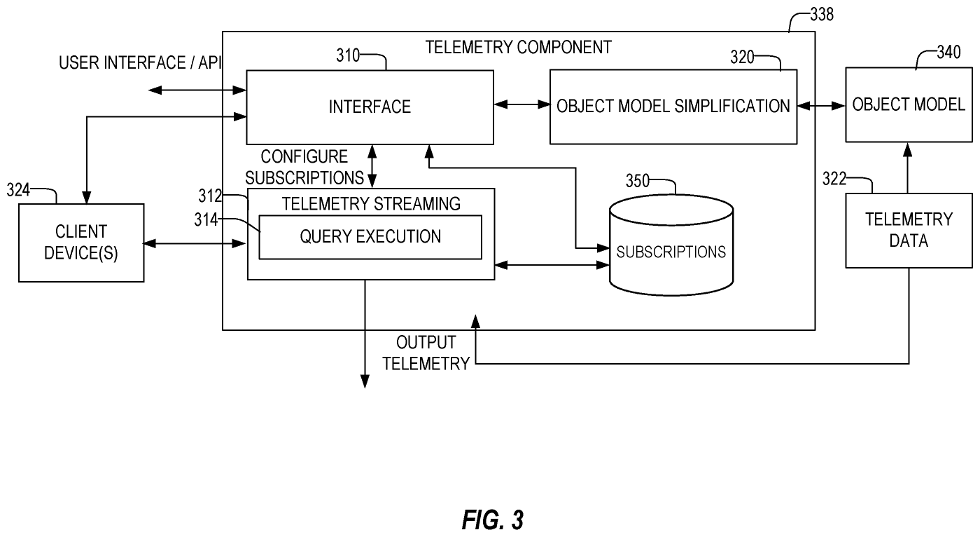

FIG. 3 illustrates a block diagram of a telemetry component 338 according to some examples of the present disclosure. Telemetry component 338 may include an interface component 310 which may provide one or more interfaces, such as GUIs, APIs, or the like for users to subscribe to receive telemetry. The interface may display or provide access to the object model 340, or a simplified object model provided by the object model simplification module 320. Users may select one or more objects in the hierarchy and then may also select telemetry associated with objects in the hierarchy. In some examples, upon selection of an object, all telemetry associated with the object may be subscribed-to. In other examples, the user may additionally select particular telemetry associated with the object to subscribe to.

In addition, users may submit queries based upon the object model. Queries may be based upon properties of the objects and/or the relationships between objects in the object model. Properties may include the type of object, a location in the 3D environment of the object, a distance between a reference point (e.g., a person moving about in the environment) and the object in the 3D environment, telemetry data associated with the object, relationships between objects in the object model, and the like. In some examples, the properties may be temporal in nature and may be readjusted. In some examples, the objects may be rearranged in the 3D model as they get dynamically created and rearranged. In these examples, the queries may be modified, either automatically or manually. Example queries may include:
Selecting objects based upon properties of the objects using queries. For example, a user may subscribe to all shader meshes in the 3D environment, or all shader meshes in a particular portion of the 3D environment.
Selecting any user object with a jitter value above a threshold value.
Selecting any object within a specified threshold distance (in the virtual environment) of a VIP user.

The interface component 310 receives the subscriptions-which may be a description of a query or one or more objects and/or telemetries for the one or more objects and stores the subscriptions in a record in a subscriptions data store 350. For query-based subscriptions the interface component 310 may store the query in the record; for subscriptions to direct objects, the interface component 310 may store the object identifiers in the record. Interface component 310 may also modify one or more subscriptions. The interface component 310 may retrieve the subscription record of the user and present the subscription record (e.g., in a UI or through an API) to the user and allow the user to modify or delete the subscriptions. Changes in the subscription are then resaved back to the data record and back into the subscriptions data store 350.

In some examples the interface component 310 and/or the telemetry streaming component 312 may communicate with one or more client devices 324 to begin streaming telemetry data corresponding to a subscription. For example, to save network bandwidth, improve application performance, and to reduce latency, the client devices 324 may not stream all telemetry data to the communication service during a communication session. In these examples, the telemetry component 338 may request that one or more of the client devices 324 begin streaming telemetry data if the one or more client devices 324 is responsible for telemetry data matching a subscription. In some examples, where the telemetry data matches a particular query, the client devices 324 that provide the telemetry may change over time. For example, if the query is to provide jitter data for users that are within a specified distance in the virtual world of a VIP user, the set of client devices that are to provide this data may change over time as users enter and leave the virtual geofence. In these examples, the telemetry streaming component 312 may track which client devices are to be providing telemetry and message these devices. Likewise, devices that no longer match the query may be instructed to stop sending telemetry to save network bandwidth, latency, and processing power.

Query execution component 314 of the telemetry streaming component 312 may periodically execute queries associated with subscriptions to determine matching telemetry data from received telemetry data and to adjust the sources of the telemetry data (e.g., ask client devices to begin sending telemetry data or to stop sending telemetry data). Additionally query execution component 314 may analyze telemetry data 322 to determine if received telemetry data 322 matches a subscription. If the received telemetry data 322 matches a subscription, then the telemetry data may be transmitted to a device corresponding to the subscription, where it may be output in a user interface.

Telemetry data 322 may be sent by one or more client device(s) 324 or may be created by the network-based communication service. For example, the telemetry data may relate to an individual user's or device's connection to the meeting such as network information, the telemetry data may relate to how the one or more devices receives data sent by the communication service, the telemetry data may relate to how the communication service receives data sent by one or more client devices 324, or it may relate to data created by the network-based communication service.

In some examples, the telemetry data 322, in the form of log files may be used to construct the object model 340. For example, the log files may include a name of an object, an identifier of the object, and an identifier of a parent and/or child objects. These may be utilized to create the object model 340.

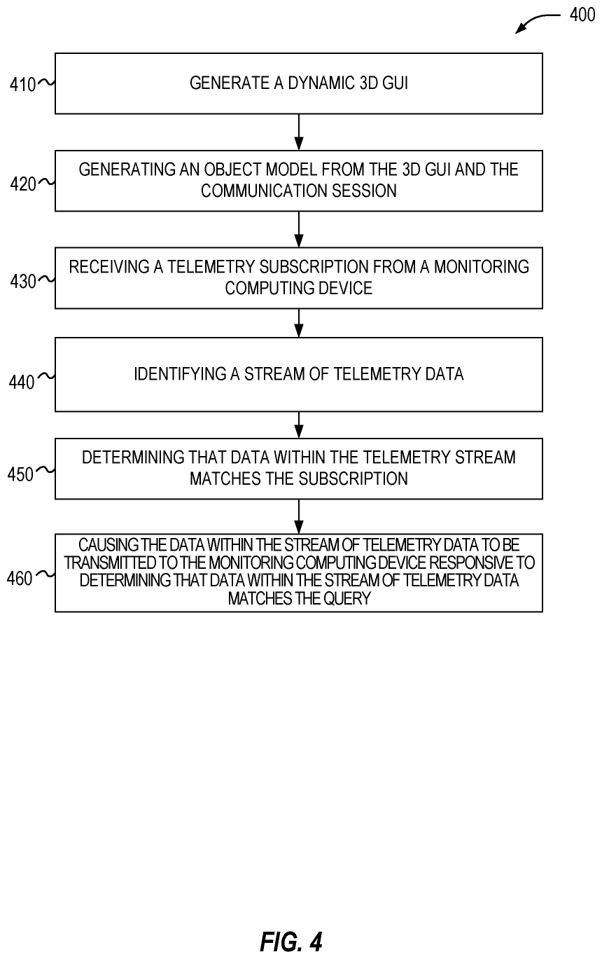

FIG. 4 illustrates a flowchart of a method 400 of providing telemetry data according to some examples of the present disclosure. At operation 410, the communication service generates a dynamic 3D GUI. Objects (either part of the environment or representing persons such as 3D avatars) may be created and destroyed as they enter and leave the 3D GUI environment. In some examples, telemetry and other objects may have timestamps associated with them, such that the system may re-use of object identifiers and still associate the correct telemetry data with the correct objects. In some examples, generating the dynamic 3D GUI may include generating one or more GUI descriptors that describe the GUI and providing those descriptors to one or more client applications for display.

At operation 420 the system may generate an object model from the 3D GUI and the communication session. In some examples, the object model is generated as part of operation 410. In other examples, the object model may be created from log data of the communication session or from past communication sessions-such as past communication sessions that utilize a same 3D environment.

At operation 430, the system may receive a telemetry subscription from a monitoring computing device. The subscription may be based upon the object model. For example, the subscription may include a query that is executed against objects in the object model to determine which telemetry data matches the query. In some examples, the object model or a simplified object model may be provided to a user of the monitoring computing device to assist the user in setting up the subscription. The user may provide one or more selections of objects or a query selecting one or more objects. In other examples, the 3D environment may be presented to the user of the monitoring computing device and the user may select or click on an object in the environment and the corresponding object may be selected as a target of the subscription. In still other examples, queries may be supplied as the subscription. Example queries include queries selecting telemetry from all objects of the object model within a prespecified distance from a particular object of the object model within the three-dimensional graphical representation; queries selecting telemetry from all objects of the object model that have a value of a telemetry parameter that satisfies a threshold condition; and the like. Queries may have conditional statements that may select all telemetry of an object matching the conditions or certain telemetry. In some examples, the query may specify that one or more client devices is to provide specific telemetry data. In these examples, client devices corresponding to objects matching a conditional statement may be instructed to begin sending this data.

At operation 440, the system may identify a stream of telemetry data. Telemetry data may be from one or more client devices participating in the communication session, the communication service, or both. The telemetry data may be identified based upon receiving the data from one or more client computing devices, the computing service, or the like.

At operation 450, the system may determine that data within the telemetry stream matches one or more subscriptions. For example, the data matches a query. At operation 460, responsive to determining that the data within the stream of telemetry data matches the query, providing this data to the computing device that is associated with the subscription. The telemetry data may be displayed on a display device of the computing device associated with the subscription. For example, the initiator of the subscription may have a user identifier and the computing device associated with the subscription may be a computing device where the user with the user identifier is logged in.

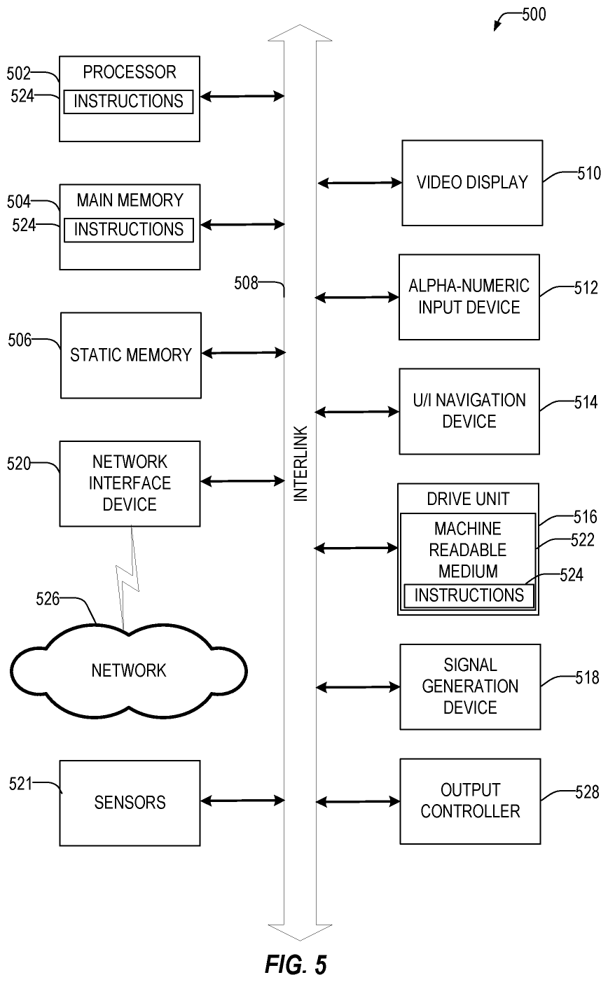

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 500 may render, or create, the GUI of FIG. 1, implement any one or more of the devices of FIG. 2, implement the telemetry component 338 of FIG. 3, and the method of FIG. 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a method for delivery of real-time telemetry data of a communication session, the communication session including a three-dimensional graphical representation, the method comprising: generating the three-dimensional graphical representation for display to participants of the communication session using data streamed from participants of the communication session, the three-dimensional graphical representation updated based upon events of the communication session concurrently as the events occur; generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session; receiving a telemetry subscription from a monitoring computing device, the telemetry subscription comprising a query against the object model and subscribing to telemetry data of the communication session matching the query; identifying a stream of telemetry data; determining that data within the stream of telemetry data matches the telemetry subscription; and causing the data within the stream of telemetry data to be transmitted to the monitoring computing device responsive to determining that data within the stream of telemetry data matches the query.

In Example 2, the subject matter of Example 1 includes, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

In Example 3, the subject matter of Examples 1-2 includes, generating a simplified object model, the simplified object model created from the object model and a set of filters; causing the simplified object model to be displayed to the monitoring computing device; and wherein receiving the telemetry subscription comprises receiving a selection of an object in the simplified object model corresponding to an object in the object model.

In Example 4, the subject matter of Examples 1-3 includes, wherein the telemetry data comprises one or more of: jitter measurements, rendering performance, packet loss, or buffer size.

In Example 5, the subject matter of Examples 1-4 includes, wherein the query selects all objects of the object model within a prespecified distance from a particular object of the object model within the three-dimensional graphical representation.

In Example 6, the subject matter of Examples 1-5 includes, wherein the query selects all objects of the object model that have a value of a telemetry parameter that satisfies a threshold condition.

In Example 7, the subject matter of Examples 1-6 includes, wherein the object model is generated from log file data.

Example 8 is a computing device for delivery of real-time telemetry data of a communication session, the communication session including a three-dimensional graphical representation, the computing device comprising: a processor; a memory, the memory storing instructions, which when executed by the processor, causes the processor to perform operations comprising: generating the three-dimensional graphical representation for display to participants of the communication session using data streamed from participants of the communication session, the three-dimensional graphical representation updated based upon events of the communication session concurrently as the events occur; generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session; receiving a telemetry subscription from a monitoring computing device, the telemetry subscription comprising a query against the object model and subscribing to telemetry data of the communication session matching the query; identifying a stream of telemetry data; determining that data within the stream of telemetry data matches the telemetry subscription; and causing the data within the stream of telemetry data to be transmitted to the monitoring computing device responsive to determining that data within the stream of telemetry data matches the query.

In Example 9, the subject matter of Example 8 includes, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

In Example 10, the subject matter of Examples 8-9 includes, wherein the operations further comprise: generating a simplified object model, the simplified object model created from the object model and a set of filters; causing the simplified object model to be displayed to the monitoring computing device; and wherein receiving the telemetry subscription comprises receiving a selection of an object in the simplified object model corresponding to an object in the object model.

In Example 11, the subject matter of Examples 8-10 includes, wherein the telemetry data comprises one or more of: jitter measurements, rendering performance, packet loss, or buffer size.

In Example 12, the subject matter of Examples 8-11 includes, wherein the query selects all objects of the object model within a prespecified distance from a particular object of the object model within the three-dimensional graphical representation.

In Example 13, the subject matter of Examples 8-12 includes, wherein the query selects all objects of the object model that have a value of a telemetry parameter that satisfies a threshold condition.

In Example 14, the subject matter of Examples 8-13 includes, wherein the object model is generated from log file data.

Example 15 is a machine-readable storage device, storing instructions for delivery of real-time telemetry data of a communication session, the communication session including a three-dimensional graphical representation, the instructions, when executed by a machine, causes the machine to perform operations comprising: generating the three-dimensional graphical representation for display to participants of the communication session using data streamed from participants of the communication session, the three-dimensional graphical representation updated based upon events of the communication session concurrently as the events occur; generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session; receiving a telemetry subscription from a monitoring computing device, the telemetry subscription comprising a query against the object model and subscribing to telemetry data of the communication session matching the query; identifying a stream of telemetry data; determining that data within the stream of telemetry data matches the telemetry subscription; and causing the data within the stream of telemetry data to be transmitted to the monitoring computing device responsive to determining that data within the stream of telemetry data matches the query.

In Example 16, the subject matter of Example 15 includes, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

In Example 17, the subject matter of Examples 15-16 includes, wherein the operations further comprise: generating a simplified object model, the simplified object model created from the object model and a set of filters; causing the simplified object model to be displayed to the monitoring computing device; and wherein receiving the telemetry subscription comprises receiving a selection of an object in the simplified object model corresponding to an object in the object model.

In Example 18, the subject matter of Examples 15-17 includes, wherein the telemetry data comprises one or more of: jitter measurements, rendering performance, packet loss, or buffer size.

In Example 19, the subject matter of Examples 15-18 includes, wherein the query selects all objects of the object model within a prespecified distance from a particular object of the object model within the three-dimensional graphical representation.

In Example 20, the subject matter of Examples 15-19 includes, wherein the query selects all objects of the object model that have a value of a telemetry parameter that satisfies a threshold condition.

In Example 21, the subject matter of Examples 15-20 includes, wherein the object model is generated from log file data.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for delivery of real-time telemetry data of a communication session, the communication session including a three-dimensional graphical representation, the method comprising:
generating the three-dimensional graphical representation for display to participants of the communication session using data streamed from participants of the communication session, the three-dimensional graphical representation updated based upon events of the communication session concurrently as the events occur;
generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session;
receiving a telemetry subscription from a monitoring computing device, the telemetry subscription comprising a query against the object model and subscribing to telemetry data of the communication session matching the query;
identifying a stream of telemetry data;
determining that data within the stream of telemetry data matches the telemetry subscription; and
causing the data within the stream of telemetry data to be transmitted to the monitoring computing device responsive to determining that data within the stream of telemetry data matches the query.

2. The method of claim 1, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

3. The method of claim 1, further comprising:
generating a simplified object model, the simplified object model created from the object model and a set of filters;
causing the simplified object model to be displayed to the monitoring computing device; and
wherein receiving the telemetry subscription comprises receiving a selection of an object in the simplified object model corresponding to an object in the object model.

4. The method of claim 1, wherein the telemetry data comprises one or more of: jitter measurements, rendering performance, packet loss, or buffer size.

5. The method of claim 1, wherein the query selects all objects of the object model within a prespecified distance from a particular object of the object model within the three-dimensional graphical representation.

6. The method of claim 1, wherein the query selects all objects of the object model that have a value of a telemetry parameter that satisfies a threshold condition.

7. The method of claim 1, wherein the object model is generated from log file data.

8. A computing device for delivery of real-time telemetry data of a communication session, the communication session including a three-dimensional graphical representation, the computing device comprising:
a processor;
a memory, the memory storing instructions, which when executed by the processor, causes the processor to perform operations comprising:
generating the three-dimensional graphical representation for display to participants of the communication session using data streamed from participants of the communication session, the three-dimensional graphical representation updated based upon events of the communication session concurrently as the events occur;
generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session;
receiving a telemetry subscription from a monitoring computing device, the telemetry subscription comprising a query against the object model and subscribing to telemetry data of the communication session matching the query;
identifying a stream of telemetry data;
determining that data within the stream of telemetry data matches the telemetry subscription; and
causing the data within the stream of telemetry data to be transmitted to the monitoring computing device responsive to determining that data within the stream of telemetry data matches the query.

9. The computing device of claim 8, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

10. The computing device of claim 8, wherein the operations further comprise:
generating a simplified object model, the simplified object model created from the object model and a set of filters;
causing the simplified object model to be displayed to the monitoring computing device; and
wherein receiving the telemetry subscription comprises receiving a selection of an object in the simplified object model corresponding to an object in the object model.

11. The computing device of claim 8, wherein the telemetry data comprises one or more of: jitter measurements, rendering performance, packet loss, or buffer size.

12. The computing device of claim 8, wherein the query selects all objects of the object model within a prespecified distance from a particular object of the object model within the three-dimensional graphical representation.

13. The computing device of claim 8, wherein the query selects all objects of the object model that have a value of a telemetry parameter that satisfies a threshold condition.

14. The computing device of claim 8, wherein the object model is generated from log file data.

15. A machine-readable storage device, storing instructions for delivery of real-time telemetry data of a communication session, the communication session including a three-dimensional graphical representation, the instructions, when executed by a machine, causes the machine to perform operations comprising:
generating the three-dimensional graphical representation for display to participants of the communication session using data streamed from participants of the communication session, the three-dimensional graphical representation updated based upon events of the communication session concurrently as the events occur;
generating an object model of the communication session, the object model comprising objects representing data about elements of the three-dimensional graphical representation and the communication session and object links between objects representing a hierarchical relationship between the elements of the three-dimensional graphical representation, objects in the object model created or destroyed responsive to their appearance or disappearance in the three-dimensional graphical representation as it is updated based upon the events of the communication session;
receiving a telemetry subscription from a monitoring computing device, the telemetry subscription comprising a query against the object model and subscribing to telemetry data of the communication session matching the query;
identifying a stream of telemetry data;
determining that data within the stream of telemetry data matches the telemetry subscription; and
causing the data within the stream of telemetry data to be transmitted to the monitoring computing device responsive to determining that data within the stream of telemetry data matches the query.

16. The machine-readable storage device of claim 15, wherein the query selects an object from the object model, the object comprises one of: a texture, a mesh, a virtual object, a set of vertices, an animation, a lighting node, a pencil, a whiteboard, an object depicted on a whiteboard, a model of a user, a canvas, an eraser, documents, graphs, or shared content.

17. The machine-readable storage device of claim 15, wherein the operations further comprise:
generating a simplified object model, the simplified object model created from the object model and a set of filters;
causing the simplified object model to be displayed to the monitoring computing device; and
wherein receiving the telemetry subscription comprises receiving a selection of an object in the simplified object model corresponding to an object in the object model.

18. The machine-readable storage device of claim 15, wherein the telemetry data comprises one or more of: jitter measurements, rendering performance, packet loss, or buffer size.

19. The machine-readable storage device of claim 15, wherein the query selects all objects of the object model within a prespecified distance from a particular object of the object model within the three-dimensional graphical representation.

20. The machine-readable storage device of claim 15, wherein the query selects all objects of the object model that have a value of a telemetry parameter that satisfies a threshold condition.
